(19) United States
(12) Patent Application Publication
(10) Pub. No.: US 2024/0163794 A1
(43) Pub. Date: May 16, 2024

(54) WAKE-UP FOR BATTERY-POWERED DEVICE

(71) Applicant: Silicon Laboratories Inc., Austin, TX (US)

(72) Inventors: Nicola Wrachien, Budapest (HU); Sandor Csullog, Budapest (HU); Muhammad Shoaib Javed, High Wycombe (GB); Brian Michael Blum, Corrales, NM (US)

(21) Appl. No.: 17/986,158

(22) Filed: Nov. 14, 2022

(51) Int. Cl. H04W 52/02

(52) U.S. Cl. CPC H04W 52/0229

(57) ABSTRACT

Embodiments of a battery-powered device are sealed in an enclosure and include a photovoltaic device that converts light to an electrical signal. The device uses the electrical signal to activate the controller and transition the device from a shelf mode to an active mode. The enclosure includes a transparent portion in line-of-sight of the photovoltaic device. The transparent portion passes external optical signals to the photovoltaic device within the enclosure. The transparent portion may be obstructed by a removable, opaque label to prevent accidental product activation. In some embodiments, after the device transitions from the shelf mode to the active mode, the controller configures a general-purpose input-output terminal as an output to maintain the active level of the activation signal, thereby maintaining the device in the active mode. In at least one embodiment, after activating the device, the controller uses the activation signal to return the device to shelf mode.

### BACKGROUND

### Field of the Invention

This application is related to integrated circuits and more particularly to providing power to integrated circuits.

### Description of the Related Art

In general, the operating life of a typical battery-powered, disposable consumer product is relatively short as compared to the shelf life of the product. The typical battery-powered, disposable consumer product includes a battery (e.g., coin battery, button cell, or watch battery) with limited charge capacity and low self-discharge. During manufacturing of the product, the battery is isolated by placing a removable thin plastic foil between the battery and its holder. To transition the product from a shelf mode (i.e., an inactive mode) to an active mode (e.g., an operating mode), a user removes the foil, thereby electrically coupling the battery to the internal circuitry. However, this technique is inconsistent with various applications (e.g., disposable medical devices) that include a sealed enclosure (e.g., a hermetically sealed enclosure) to prevent moisture or other contamination from damaging the product and to prevent the product from being a source of contamination or infection in the application.

A conventional technique for increasing the shelf life of a sealed battery-powered product includes electrically coupling a battery to a controller and configuring the controller in its lowest power mode. The controller wakes up periodically to determine whether to enter the active mode, e.g., in response to detecting an external Bluetooth™ signal to trigger pairing of the product to another Bluetooth device. Typically, the lowest power mode still consumes more than 100 nanoamperes (nA) and the selection of a frequency of transitioning the controller from its lowest power mode to an active mode is a trade-off between battery life and user experience. If the frequency is too low, i.e., the interval between wake-up events is too long, then the user experience degrades. If the frequency is too high, i.e., the interval between wake-up events is too short, the average current consumption increases, which decreases the shelf life of the product.

Another technique for increasing the shelf life of a sealed, battery-powered product uses a controller that includes an enable input, which allows the device to be configured in an active mode only when required, and consumes an ultra-low current (e.g., a few nA) in the shelf mode. However, in the shelf mode, the device cannot listen for external stimulus other than stimulus on the enable input. Therefore, the device cannot perform certain operations, e.g., listen for a signal of a Bluetooth system. Alternative techniques for providing the enable signal include using a mechanical switch (e.g., a push button), a magnetic switch (e.g., an external, removable, magnet maintains contacts of a magnetic switch in an open position and removal of the magnet causes the contacts to close), or near field communications to provide the activation signal. Use of a mechanical switch includes a flexible membrane on the enclosure and a mechanism that prevents accidental turn-on. Magnetic switches are relatively expensive and require an external magnet. Near field communications circuitry is complex, expensive, and requires an external device to generate the signal. Accordingly, improved techniques for waking up enclosed, battery-powered circuits from a shelf mode are desired.

### SUMMARY OF EMBODIMENTS OF THE INVENTION

In at least one embodiment, an integrated circuit product includes an energy harvesting circuit configured to provide an activation signal in response to receiving an electromagnetic signal. The integrated circuit product includes a controller comprising a power input terminal. The controller transitions from an ultra-low power mode of operation to an active mode of operation in response to the activation signal transitioning to an active level from an inactive level. The integrated circuit product includes a feedback circuit configured to maintain the activation signal at the active level after the electromagnetic signal disappears. The integrated circuit product may include an enclosure having a transparent portion. The transparent portion passes the electromagnetic signal from outside the enclosure to the energy harvesting circuit. The integrated circuit product may include a removable barrier covering the transparent portion while the integrated circuit product is unused. The integrated circuit product may include a battery selectively coupled to the power input terminal according to a level of the activation signal.

In at least one embodiment, a method for activating an integrated circuit product includes generating an activation signal having an active level in response to energy harvested from an electromagnetic signal received via a transparent portion of an enclosure. The method includes transitioning a controller from an ultra-low power mode of operation to an active mode of operation in response to the activation signal transitioning to the active level from an inactive level. The method may include, in response to the active level of the activation signal, driving an output signal to maintain the controller in the active mode of operation after disappearance of the electromagnetic signal. The method may include removing a barrier from the transparent portion of the enclosure and applying the electromagnetic signal to the transparent portion of the enclosure.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a circuit diagram of a wake-up circuit in an enclosed, battery-powered application including a microcontroller having a power terminal, an enable terminal, and a keep-alive terminal consistent with at least one embodiment of the invention.

FIG. 2 illustrates a circuit diagram of a wake-up circuit in an enclosed, battery-powered application including a microcontroller having a power terminal and a keep-alive terminal, but without an enable terminal consistent with at least one embodiment of the invention.

FIG. 3 illustrates a circuit diagram of a wake-up circuit in an enclosed, battery-powered application including a microcontroller having a power terminal and without an enable terminal or a keep-alive terminal consistent with at least one embodiment of the invention.

FIG. 4 illustrates a cross-section of a packaged battery-powered device including a wake-up circuit in a low-power, battery-powered application in shelf mode consistent with at least one embodiment of the invention.

FIG. 5 illustrates a cross-section of a packaged battery-powered device including a wake-up circuit in a low-power, battery-powered application being activated using a light source consistent with at least one embodiment of the invention.

The use of the same reference symbols in different drawings indicates similar or identical items.

### DETAILED DESCRIPTION

Embodiments of a battery-powered device are sealed in an enclosure and include an energy harvesting circuit (e.g., a circuit including a photovoltaic device) that converts an electromagnetic signal (e.g., visible light) to an electrical signal. The device uses the electrical signal to activate the controller and transition the device from a shelf mode (e.g., an ultra-low power operating mode) to an active mode (e.g., a regular operating mode having higher power levels than the shelf mode). The enclosure includes a transparent portion in line-of-sight of the photovoltaic device. The transparent portion passes external optical signals to the photovoltaic device within the enclosure. The transparent portion may be obstructed by a removable, opaque label to prevent accidental product activation, e.g., by ambient light. In some embodiments, after the device transitions from the shelf mode to the active mode, the controller configures terminal to maintain the active level of the activation signal, thereby maintaining the device in the active mode. In the shelf mode, that GPIO terminal is configured in a high impedance state to prevent interference with signal generation of the photovoltaic device. In at least one embodiment, after activating the device, the controller uses the activation signal to return the device to shelf mode. For example, if the device detects no activity (e.g., pairing has not occurred in a Bluetooth application) for a predetermined time, then the controller transitions the activation signal from an active signal level to an inactive signal level, and the device returns to shelf-mode.

In at least one embodiment, the photovoltaic device includes a series of silicon photodiodes, i.e., light-sensitive semiconductor diodes that each generate a voltage across a p-n junction of a semiconductor when the junction is exposed to light. In at least one embodiment, the photovoltaic device includes a blue light-emitting diode (LED), which generates a voltage across its terminals that is sufficient for some applications. However, one or more other LEDs that emit light of other colors may be used. A user activates the battery-powered product by removing an opaque label over the transparent portion, if any, and shining a strong light (e.g., a flashlight LED of a consumer smart phone) in a line-of-sight of the photovoltaic device.

Referring to FIG. 1, in at least one embodiment, device 100 is a battery-powered device sealed in an enclosure (not shown). Microcontroller 102 includes terminal ENABLE. When terminal ENABLE is low, device 100 is inactive (i.e., in shelf mode) and consumes an ultra-low current (e.g., a few nA) from battery 104 (e.g., a button cell). When terminal ENABLE receives a voltage level that exceeds a predetermined threshold voltage, microcontroller 102 transitions into an active mode of operation and consumes a regular amount of current (e.g., an instantaneous current of 10-20 mA but an average current over a period of time in the range between a few hundred nA to tens of microamperes (μA)), which varies with the application. In some embodiments of device 100, the regular amount of current consumed in the active mode of operation is several orders of magnitude larger than the current consumption in the shelf mode.

In at least one embodiment, photovoltaic device 106 is a blue light emitting diode configured in a photovoltaic mode. In other embodiments, photovoltaic device 106 includes a plurality of silicon photodiodes coupled in series, or other photovoltaic device that provides a suitable electrical signal (e.g., 1.5 V) in response to sufficient illumination. If an insufficient amount of light is incident on photovoltaic device 106, device 100 remains in shelf mode, terminal ENABLE is coupled to 0 V via resistor 110 (e.g., 10 Megaohms), microcontroller 102 draws only ultra-low current (e.g., about 10 nA) from battery 104, and terminal KEEP-ALIVE (e.g., a GPIO terminal) is configured in a high impedance state. Note that the signal levels and sizes of circuit elements will vary with specifications for the actual implementation of microcontroller 102.

If sufficient light is incident on photovoltaic device 106, a voltage (e.g., 2V) develops across photovoltaic device 106 and photovoltaic device 106 generates a current in the μA range, which is sufficient to activate device 100 for the low-power application, but low enough to prevent a latch-up event even if the voltage across photovoltaic device 106 exceeds the voltage of battery 102 (e.g., 1.5 V). The current flows through diode 108 to terminal ENABLE, which transitions device 100 to an active mode (e.g., by enabling a boost power converter in microcontroller 102 that turns on microcontroller 102). In an embodiment, resistor 110 has a value that is compatible with device 100 using direct sunlight or a flashlight LED of a smart phone that has a luminous flux of approximately 50 lumens proximate to the device (e.g., 1 centimeter) to cause device 100 to enter the active mode. Execution by microcontroller 106 of firmware stored in memory 130 configures terminal KEEP-ALIVE to have a voltage level (e.g., high) that maintains terminal ENABLE at a high level and maintains that voltage level when the light source is removed and a strong light is no longer incident on photovoltaic device 106. In at least one embodiment, firmware executing on microcontroller 102 can configure terminal KEEP-ALIVE in a low state, returning device 100 back to shelf mode. In at least one embodiment, firmware executing on microcontroller 102 can be used to exercise device 100 for factory configuration or manufacturing testing before returning device 100 back to shelf mode. In at least one embodiment, memory 100 is a low-power non-volatile memory, e.g., flash memory. Although memory 130 is illustrated as being included in microcontroller 102, in other embodiments of device 100, memory external to the microcontroller is used.

Capacitor 112 (e.g., 10 nanofarads (nF)) charges and stores energy sufficient to provide a DC signal even if the light source used to activate device 100 is pulse-width modulated to communicate data to microcontroller 102. Diode 108 prevents photovoltaic device 106 from becoming forward-biased when terminal KEEP-ALIVE has a high signal level, thereby reducing power consumption of device 100. Diode 108 also allows device 100 to use photovoltaic device 106 as a photodetector, e.g., to receive data for secure pairing. For example, terminal GPIO and smoothing filter 114 are configured to pass data for applications that modulate the activation light at a low frequency. In an embodiment, an application executing on a smartphone modulates an LED flashlight of the smartphone to send a bit stream of data (e.g., data transmitted out of band for a Bluetooth application). Circuits of FIG. 1 are exemplary only and other equivalent circuits providing the functions described above may be used.

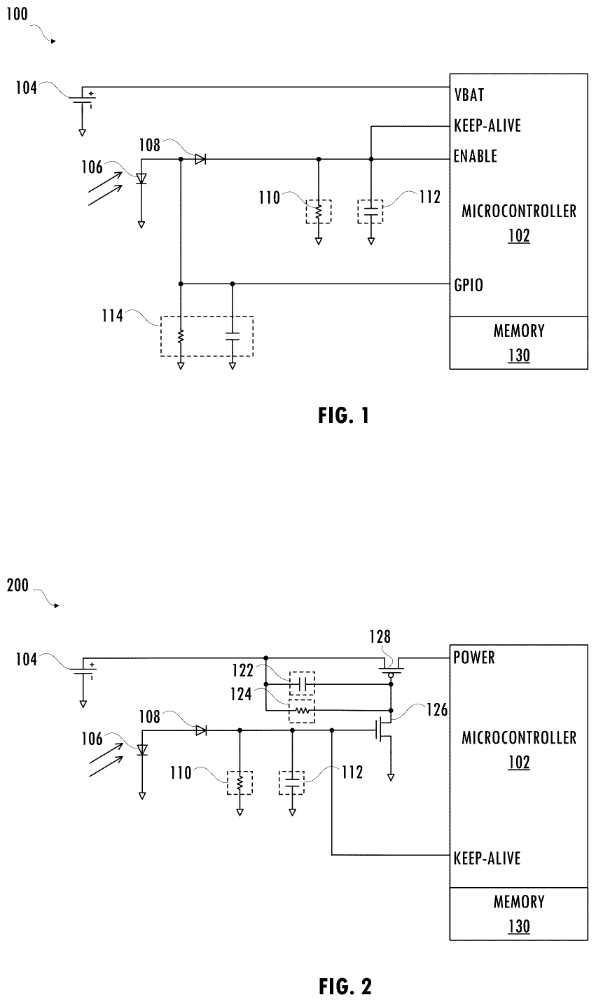

Referring to FIG. 2, in at least one embodiment of device 200, microcontroller 102 of device 200 does not have a terminal dedicated to receiving an enable signal and additional circuitry (e.g., low power discrete transistors and discrete passive devices or an additional integrated circuit providing corresponding functionality) is included to implement functions described above. In an embodiment of device 200, p-type transistor 128 and n-type transistor 126 are configured to selectively enable microcontroller 102. In at least one embodiment, n-type transistor 126 and p-type transistor 128 are metal-oxide semiconductor field effect transistors (MOSFETs) having threshold voltages that are low enough for operation in a low power (e.g., 1.5 V) system and turn on using low currents. When device 200 is configured in shelf mode and light incident on photovoltaic device 106 is insufficient to generate a signal having a voltage greater than the threshold voltage of n-type transistor 126, terminal KEEP-ALIVE is configured in a high impedance state causing the gate of n-type transistor 126 to have a voltage level below a threshold voltage of n-type transistor 126. Resistor 110 maintains the gate of n-type transistor 126 at the logic low level and n-type transistor 126 is off. P-type transistor 128 is also off since resistor 124 (e.g., 10 Megaohms) maintains the gate-to-source voltage at 0 V. Accordingly, battery consumption is mainly due to parasitic current leakage of n-type transistor 126 and p-type transistor 128. In at least one embodiment, capacitor 122 (e.g., 10 nF) reduces the likelihood of accidental activation when battery 104 is mounted to a printed circuit board during manufacturing.

In at least one embodiment, when light incident on photovoltaic device 106 is sufficient to generate a voltage greater than the threshold voltage of n-type transistor 126, n-type transistor 126 turns on and causes conduction in p-type transistor 128, thereby coupling battery 104 to terminal POWER and enables microcontroller 102. Microcontroller 102 then configures terminal KEEP-ALIVE to have a high voltage, which maintains n-type transistor 126 in an on state even when the external light disappears. Circuits of FIG. 2 are exemplary only and other equivalent circuits providing the functions described above may be used.

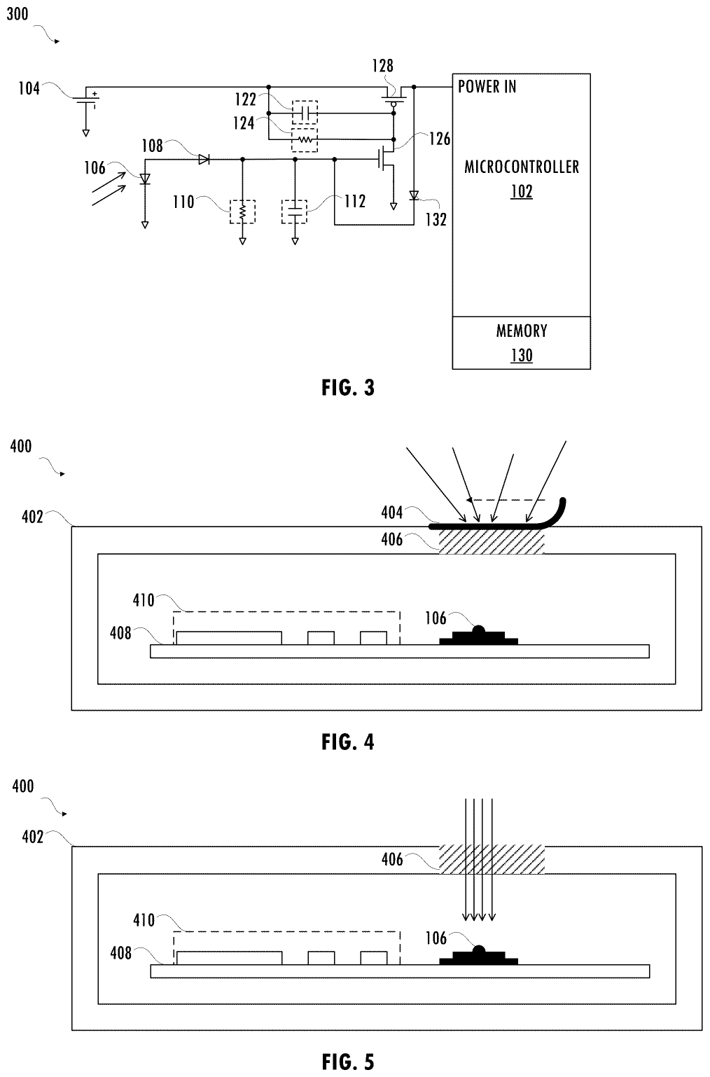

In another embodiment (FIG. 3), microcontroller 102 of device 300 does not have an output terminal configured to maintain an activation signal level. Instead, diode 132 feeds back the voltage on the drain of p-type transistor 128 to the gate of n-type transistor 126 to provide the keep-alive functionality. However, in this embodiment, after activating device 300, software executing on microcontroller 102 is unable to return device 300 to shelf mode. Circuits of FIG. 3 are exemplary only and other equivalent circuits providing the functions described above may be used.

Referring to FIGS. 4 and 5, device 400 is a battery-powered device sealed in enclosure 402. Device 400 includes photovoltaic device 106 and components 410 (e.g., battery, a microcontroller, a memory, and associated discrete circuit components described above) mounted on printed circuit board 408. Enclosure 402 includes transparent portion 406 and the remainder of enclosure 402 is opaque (e.g., absorbs, scatters, or reflects light). In shelf mode, transparent portion 406 is obstructed by opaque label 404 that prevents unintentional product activation by ambient light that may be incident on enclosure 402. Embodiments of opaque label 404 include a small piece of opaque material (e.g., paper, fabric, plastic, or other suitable material) that is affixed to enclosure 402 but is easily removed or repositioned from obstructing the transparent portion, and in some embodiments, is easily reaffixed or repositioned again later to obstruct enclosure 402. Removal or repositioning of opaque label 404 exposes transparent portion 406, which passes light. Shining a light in a line-of-sight of photovoltaic device 106 causes a voltage to develop across photovoltaic device 106. When the voltage is high enough, the signal generated by photovoltaic device 106 enables components 410 to activate device 400.

In embodiments described above that are capable of returning to shelf mode, a user may replace opaque label 404 after activation of device 400 and return device 400 to shelf mode or use another opaque barrier to prevent unintended reactivation of device 400. In some embodiments, photovoltaic device 106 is replaced with another energy harvesting device (e.g., a thermoelectric generator, etc.) that can generate the signal used to activate device 400 and transparent portion 406 passes another type of electromagnetic radiation (e.g., radio frequency waves, microwaves, infrared signals) that is compatible with the energy harvesting device, properties of opaque label 404, and properties of opaque portions of enclosure 402.

Structures described herein may be implemented using software executing on a processor (which includes firmware) or by a combination of software and hardware. Software, as described herein, may be encoded in at least one tangible (i.e., non-transitory) computer readable medium. As referred to herein, a tangible computer-readable medium includes at least an electronic storage medium.

The description of the invention set forth herein is illustrative and is not intended to limit the scope of the invention as set forth in the following claims. The terms “first,” “second,” “third,” and so forth, as used in the claims, unless otherwise clear by context, is to distinguish between different items in the claims and does not otherwise indicate or imply any order in time, location or quality. For example, “a first received signal,” “a second received signal,” does not indicate or imply that the first received signal occurs in time before the second received signal. Variations and modifications of the embodiments disclosed herein may be made based on the description set forth herein, without departing from the scope of the invention as set forth in the following claims.

What is claimed is:

1. An integrated circuit product comprising:
an energy harvesting circuit configured to provide an activation signal in response to receiving an electromagnetic signal; and
a controller comprising a power input terminal and an output terminal, the controller transitioning from an ultra-low power mode of operation to an active mode of operation in response to the activation signal transitioning to an active level from an inactive level; and
a feedback circuit configured to maintain the activation signal at the active level after the electromagnetic signal disappears.

2. The integrated circuit product as recited in claim 1 wherein the electromagnetic signal is visible light and the energy harvesting circuit includes a photovoltaic device.

3. The integrated circuit product as recited in claim 1 further comprising:
an enclosure having a transparent portion, the transparent portion passing the electromagnetic signal from outside the enclosure to the energy harvesting circuit.

4. The integrated circuit product as recited in claim 3 further comprising:
a removable barrier covering the transparent portion while the integrated circuit product is unused.

5. The integrated circuit product as recited in claim 1 wherein the energy harvesting circuit provides a DC signal as the activation signal to a first node coupled to the output terminal when the controller is configured in the ultra-low power mode of operation and prevents current from flowing into the energy harvesting circuit from the output terminal when the controller is configured in the active mode of operation.

6. The integrated circuit product as recited in claim 1 further comprising:
a battery selectively coupled to the power input terminal according to a level of the activation signal.

7. The integrated circuit product as recited in claim 6 wherein the output terminal provides a control signal from the controller to selectively couple the battery to continue providing power to the controller after the activation signal disappears.

8. The integrated circuit product as recited in claim 1 further comprising:
a filter circuit coupled to the energy harvesting circuit,
wherein the controller further comprises an additional input terminal coupled to the filter circuit and configured to receive low frequency data from the filter circuit while the electromagnetic signal is received, and
wherein the activation signal is further based on validation of the low frequency data.

9. The integrated circuit product as recited in claim 1 wherein the energy harvesting circuit comprises a light-emitting diode configured in photovoltaic mode.

10. The integrated circuit product as recited in claim 1
wherein the controller is configured to execute instructions stored in a memory, the instructions being executable by the controller to cause the controller to generate a signal that maintains the active level of the activation signal after the electromagnetic signal disappears, and
wherein the controller causes the signal to disable the activation signal to return the controller to the ultra-low power mode of operation in response to an absence of activity for a predetermined time.

11. A method for activating an integrated circuit product, the method comprising:
generating an activation signal having an active level in response to energy harvested from an electromagnetic signal received via a transparent portion of an enclosure; and
transitioning a controller from an ultra-low power mode of operation to an active mode of operation in response to the activation signal transitioning to the active level from an inactive level.

12. The method as recited in claim 11 wherein the electromagnetic signal is visible light and the method further comprises harvesting the energy from the visible light using a photovoltaic device.

13. The method as recited in claim 11 further comprising:
in response to the active level of the activation signal, driving an output signal to maintain the controller in the active mode of operation after disappearance of the electromagnetic signal.

14. The method as recited in claim 13 further comprising:
removing a barrier from the transparent portion of the enclosure; and
applying the electromagnetic signal to the transparent portion of the enclosure.

15. The method as recited in claim 11 further comprising:
in response to the active level of the activation signal, coupling the controller to a battery; and
maintaining the controller in the active mode of operation after disappearance of the electromagnetic signal.

16. The method as recited in claim 15 further comprising:
decoupling the controller from the battery and returning the controller to the ultra-low power mode of operation from the active mode of operation in response to the disappearance of the electromagnetic signal and inactivity for a predetermined amount of time.

17. The method as recited in claim 13 further comprising:
returning the controller to the ultra-low power mode of operation from the active mode of operation in response to instructions executing on the controller.

18. The method as recited in claim 11 further comprising:
receiving low frequency data while the electromagnetic signal is received, wherein the activation signal is further based on validation of the low frequency data.

19. An integrated circuit product comprising:
a battery;
a controller circuit coupled to the battery;
an enclosure surrounding the battery and the controller circuit; and
means for initiating entry of the controller circuit into an active mode from an ultra-low-power mode of operation using energy harvested from an electromagnetic signal passed by the enclosure.

20. The integrated circuit product as recited in claim 19 further comprising:
means for returning the controller circuit to the low-power mode from the active mode in response to a disappearance of the electromagnetic signal and an absence of activity for a predetermined amount of time.
